(19) United States
(12) Patent Application Publication
(10) Pub. No.: US 2002/0184519 A1
(43) Pub. Date: Dec. 5, 2002

(54) Methods and systems for managing printing resources

(76) Inventor: Donald K. Wadley, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/874,194

(22) Filed: Jun. 4, 2001

(51) Int. Cl. G06F 11/30

(52) U.S. Cl. 713/200

(57) ABSTRACT

Methods and systems for operating printers are described. In one embodiment a printer is monitored by a printer monitor that is configured to monitor one or more variables or parameters associated with the security of the printer. The printer monitor can be internal or external to the printer. In the event that the printer monitor detects a security breach, the printer monitor is configured to notify a printer authority. Exemplary variables or parameters that can be monitored by the printer monitor include, without limitation, those associated with I/O activities of the printer, memory usage activities, various metrics associated with data that is received by and then transmitted from the printer.

### TECHNICAL FIELD

This invention relates to methods and systems of managing printing resources, and, in particular, to methods and systems of managing organizational printing resources.

### BACKGROUND

Printers, particularly those that can be used by companies or organizations, are often used to print a wide range of material. Such material typically includes information that may or may not be sensitive. For example, such sensitive material might include financial records, performance evaluations, resumes and the like. To date, a great deal of effort has been expended by those in the printing industry to provide security solutions for printers so that sensitive material is printed only by those individuals who are authorized to print it or on authorized print resources. Exemplary security solutions include the use of lock boxes, secure printing environments, printer access codes that restrict the use of the printer to certain individuals or that restrict the access that individuals have to various resources. Needless to say, there have been many and varied attempts to solve printer security issues.

The security issue underscores or exemplifies a more general need within organizations that touches upon the ability (or lack thereof) of an organization to efficiently, effectively and robustly manage its printer resources.

In recent years, within the printer industry, there have been attempts to increase the value that third party vendors can provide for printers. Specifically, efforts have been expended to standardize both the hardware and software interfaces that third party vendors can use. As a result, these vendors can write software programs or add hardware or firmware that interact with the printer in a more meaningful way. Thus, in some respects, some printer manufacturers, such as the assignee of this document, can provide a printer platform that can then be “extended” by other third parties such as third party software vendors.

In the recent past, attempts to standardize the printer interfaces have been made with the ultimate goal of simplicity in mind. For example, defining software interfaces so that a standardized programmatic approach can be used to interact with the interface can greatly facilitate third party interaction. As an example, using Java-based interfaces can allow those with Java programming expertise to interact in a meaningful and robust way with the printer and the data that it contains. Such interaction is typically facilitated by a Java Virtual Machine (JVM) that is incorporated as part of a printer's software. JVM's are known, examples of which are described in U.S. Pat. Nos. 6,115,719, 5,943,496, 6,170,083, 6,110,226, and 6,070,173.

Having standardized interfaces can thus allow access to great variety of information within the printer. For example, using an interface, one can access and use information concerning the status of the internal components of the printer (i.e. toner, buffers, and the like). In addition, the incoming data stream can be accessed through an appropriate interface so that, for example, it can be converted into a different format for printing. Accordingly, as will be appreciated by those of skill in the art, the present state of printer technology is such that robust interaction can be had with printers through various interfaces that are provided on the printers or on their software.

Against this backdrop, there exists a continuing need to provide a high degree of interaction with printers. This is true not only from the security standpoint, but more generally, from the resource management standpoint.

This invention arose out of concerns associated with providing improved methods and systems for interacting with and managing printers. This invention also arose out of concerns associated with providing improved security systems and methods that can be used in today's robust printer environment.

### SUMMARY

Methods and systems for operating printers are described. In one embodiment a printer is monitored by a printer monitor that is configured to monitor one or more variables or parameters associated with the security of the printer. The printer monitor can be internal or external to the printer. In the event that the printer monitor detects a security breach, the printer monitor is configured to notify a printer authority. Exemplary variables or parameters that can be monitored by the printer monitor include, without limitation, those associated with I/O activities of the printer, memory usage activities, various metrics associated with data that is received by and then transmitted from the printer.

### BRIEF DESCRIPTION OF THE DRAWINGS

The same numbers are used throughout the drawings to reference like features and components.

FIG. 1 is an illustration of an exemplary network in which the inventive techniques and systems can be employed.

FIG. 2 is a block diagram that illustrates various components of an exemplary printer.

FIG. 3 is a block diagram that illustrates various components of an exemplary work station.

FIG. 4 is a block diagram that illustrates selected components of a printer in accordance with one embodiment.

FIG. 5 is a diagram that illustrates an exemplary enterprise network in which the inventive techniques and systems can be employed.

FIG. 6 is a block diagram that illustrates an exemplary context-analyzer in accordance with one embodiment.

FIG. 7 is a flow diagram that describes steps in a method in accordance with one embodiment.

FIG. 8 is a flow diagram that describes steps in a method in accordance with one embodiment.

FIG. 9 is a block diagram that illustrates an exemplary printer monitor in accordance with one embodiment.

FIG. 10 is a block diagram that illustrates an exemplary printer monitor in accordance with one embodiment.

FIG. 11 is a block diagram that illustrates an exemplary printer monitor in accordance with one embodiment.

FIG. 12 is a block diagram that illustrates an exemplary printer monitor in accordance with one embodiment.

FIG. 13 is a flow diagram that describes steps in a method in accordance with one embodiment.

### DETAILED DESCRIPTION

Overview

The methods and systems described below provide a means by which an organization can monitor the content of documents being printed on organization printer resources. The techniques permit monitoring software to be installed on a printer. The monitoring software processes data streams that are received into the printer and which are intended for printing, and determines, based on a potential variety of factors, whether the data streams are associated with documents that are of interest to the organization. If a data stream is determined to be associated with a document of interest to the organization, the organization can be notified to that effect.

In addition methods and systems are described that provide for printer security. Printer monitors monitor one or more printers and determine whether there has been a situation occur that is indicative of a security breach. If such a situation occurs, the printer monitors are configured to take an appropriate programmed action.

Exemplary Network Environment

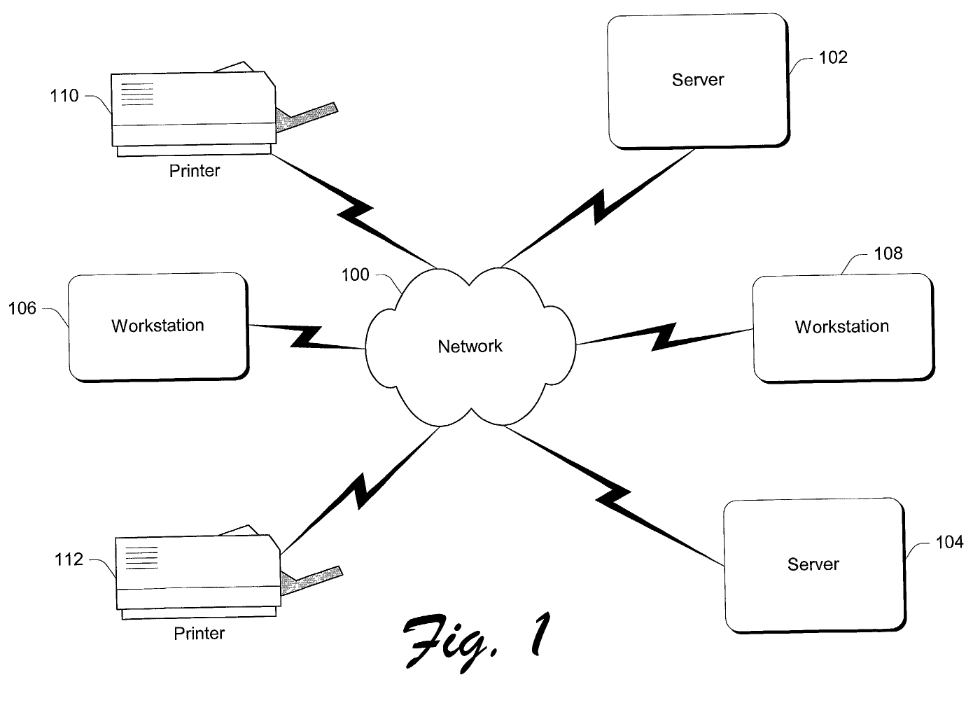

FIG. 1 illustrates a network environment in which the inventive techniques and structures described herein can be employed. The network environment can comprise multiple servers, workstations, and printers that are coupled to one another via a data communication network 100. The network 100 couples together servers 102 and 104, computer workstations 106 and 108, and printers 110 and 112. Network 100 can be any type of network, such as a local area network (LAN) or a wide area network (WAN), using any type of network topology and any network communication protocol. Although only a few devices are shown coupled to network 100, a typical network may have tens or hundreds of devices coupled to one another. Furthermore, network 100 may be coupled to one or more other networks, thereby providing coupling between a greater number of devices. Such can be the case, for example, when networks are coupled together via the Internet.

Servers 102 and 104 may be file servers, email servers, database servers, or any other type of network server. Workstations 106 and 108 can be any type of computing device, such as a personal computer. In particular embodiments, printers 110 and 112 can be laser printers. However, alternate embodiments can be implemented in connection with ink-jet or any other type of printer.

Exemplary Printer Architecture

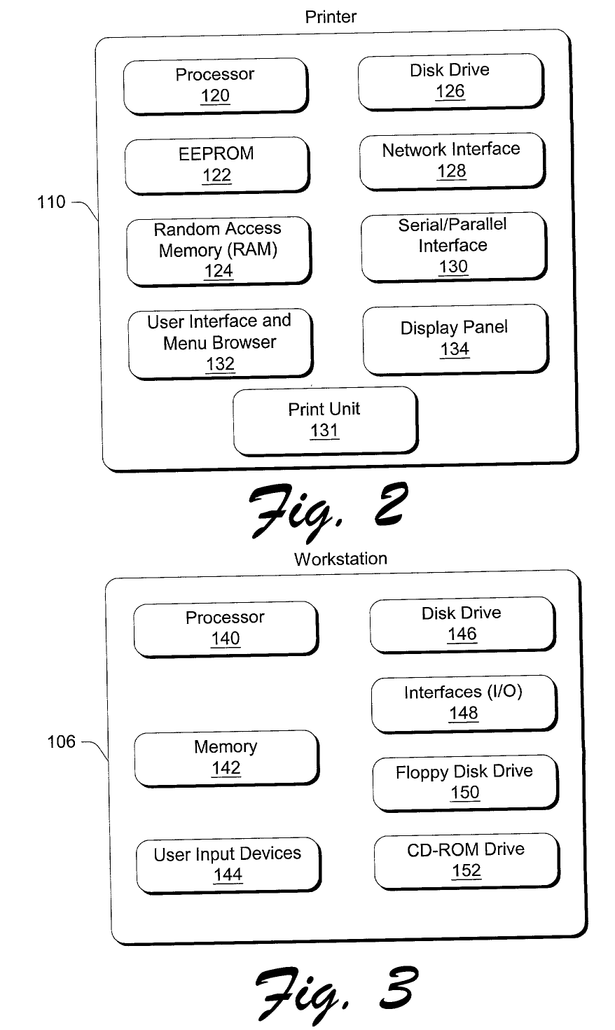

FIG. 2 is a block diagram showing exemplary components of printer 110 in accordance with one embodiment. Printer 110 includes a processor 120, an electrically erasable programmable read-only memory (EEPROM) 122, and a random access memory (RAM) 124. Processor 120 processes various instructions necessary to operate the printer 110 and communicate with other devices. EEPROM 122 and RAM 124 store various information such as configuration information, fonts, templates, data being printed, and menu structure information. Although not shown in FIG. 2, a particular printer may also contain a ROM (non-erasable) in place of or in addition to EEPROM 122. Furthermore, a printer may alternatively contain a flash memory device in place of or in addition to EEPROM 122.

Printer 110 also includes a disk drive 126, a network interface 128, and a serial/parallel interface 130. Disk drive 126 provides additional storage for data being printed or other information used by the printer 110. Although both RAM 124 and disk drive 126 are illustrated in FIG. 2, a particular printer may contain either RAM 124 or disk drive 118, depending on the storage needs of the printer. For example, an inexpensive printer may contain a small amount of RAM 124 and no disk drive 118, thereby reducing the manufacturing cost of the printer. Network interface 128 provides a connection between printer 110 and a data communication network, such as network 100. Network interface 128 allows devices coupled to a common data communication network to send print jobs, menu data, and other information to printer 110 via the network. Similarly, serial/parallel interface 130 provides a data communication path directly between printer 110 and another device, such as a workstation, server, or other computing device. Although the printer 110 shown in FIG. 2 has two interfaces (network interface 128 and serial/parallel interface 130), a particular printer may only contain one interface.

Printer 110 also includes a print unit 131 that includes mechanisms that are arranged to selectively apply ink (e.g., liquid ink, toner, etc.) to a print media (e.g., paper, plastic, fabric, etc.) in accordance with print data within a print job. Thus, for example, print unit 131 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner. Print unit 131 can also be configured to support duplex printing, for example, by selectively flipping or turning the print media as required to print on both sides. Those skilled in the art will recognize that there are many different types of print units available, and that for the purposes of the present invention print unit 131 can include any of these various types.

Printer 110 also contains a user interface/menu browser 132 and a display panel 134. User interface/menu browser 132 allows the user of the printer to navigate the printer's menu structure. User interface 132 may be a series of buttons, switches or other indicators that are manipulated by the user of the printer. Display panel 134 is a graphical display that provides information regarding the status of the printer and the current options available through the menu structure.

The illustrated printer can, and typically does include software that provides a runtime environment in which software applications or applets can run or execute. One exemplary runtime environment is a Java Virtual Machine (JVM). Other runtime environments can, of course, be used. The runtime environment can facilitate the extensibility of the printer by allowing various interfaces to be defined that, in turn, allow applications or applets to interact with the printer in more robust manners.

Exemplary WorkStation Architecture

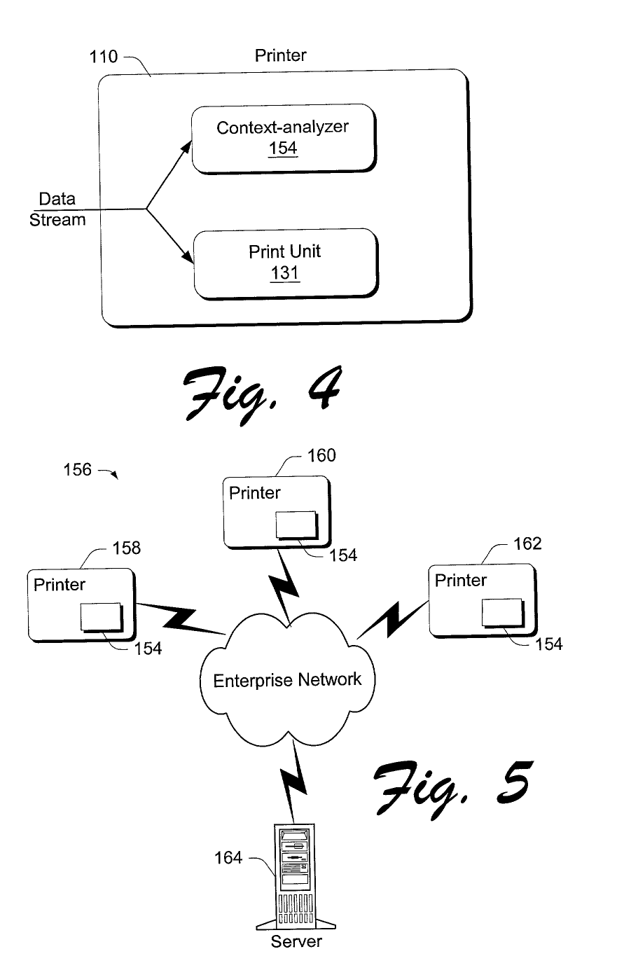

FIG. 3 is a block diagram showing exemplary components of a computer workstation 106. Workstation 106 includes a processor 140, a memory 142 (such as ROM and RAM), user input devices 144, a disk drive 146, interfaces 148 for inputting and outputting data, a floppy disk drive 150, and a CD-ROM drive 152. Processor 140 performs various instructions to control the operation of workstation 106. Memory 142, disk drive 146, and floppy disk drive 150, and CD-ROM drive 152 provide data storage mechanisms. User input devices 144 include a keyboard, mouse, pointing device, or other mechanism for inputting information to workstation 106. Interfaces 148 provide a mechanism for workstation 106 to communicate with other devices.

Exemplary Context-Analyzer

FIG. 4 shows printer 110 with only a couple of components for purposes of the explanation that follows. These components include print engine 131 and a context-analyzer 154. The context-analyzer is preferably implemented in software and resides within the printer. In embodiments where the printer includes a runtime environment, such as Java Virtual Machine, the context-analyzer resides in or is supported by the runtime environment. It should be appreciated and understood that while the context analyzer is shown as being located entirely within the confines of printer 110, various aspects of its functionality can be distributed across different computing devices.

As a data stream is received by printer 110 for printing, the data stream is typically processed for printing. Eventually, the data stream is provided to print engine 131 for printing onto a media as described above. In accordance with one described embodiment, context-analyzer 154 also receives the data stream and is configured to analyze the data stream. The analysis that is performed on the data stream by the context-analyzer pertains to, as the name implies, the context of the data stream itself. That is, each data stream that is printed by the printer necessarily has some context associated with it. For example, the data stream might represent an employment report, financial report, personnel evaluation, resume, or some other specific type of document. The context-analyzer is programmed to receive the data stream, analyze the data stream, and then provide some type of information regarding the type of document that has been printed.

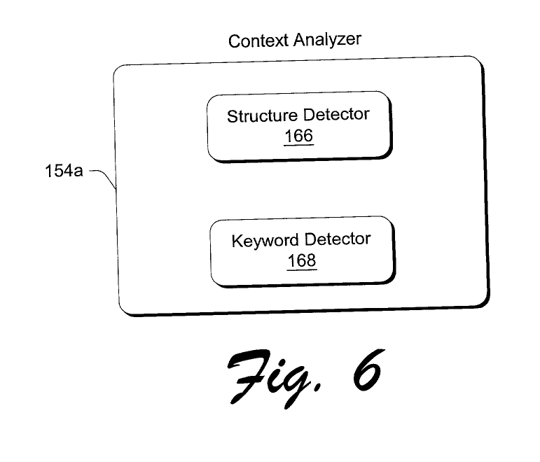

As an example, consider FIG. 5 which shows an enterprise network 156 that includes three exemplary printers 158, 160, 162. Each printer is configured with a context-analyzer 154. A server computer 164 is provided and is communicatively linked with the printers via the network. Assume that in this organization, the organization is very interested in performing statistical analysis regarding the usage characteristics of each of its printer resources. That is, the organization desires to determine what types of documents are printed on the organization's various printer resources, and the numbers of such documents. In this example, context-analyzer 154 on each printer can be programmed to ascertain the context of each document that is printed on a printer by looking specifically at the data stream that defines the document. By analyzing the data stream, each context-analyzer can accumulate information pertaining to the data stream that can then be used to ascertain the type of documents that are being printed by the printer. This accumulated information can be processed by the individual context-analyzers to make determinations concerning their own documents, or the accumulated information can be provided to another entity, e.g. server computer 164, for such determinations.

Consider further the case where an organization is concerned with tracking or monitoring security issues. For example, in a particular organization, printer 158 may be a secure printer that is designated for printing sensitive material, while printers 160 and 162 are located in areas where they are not secure and so cannot be used for sensitive material. By having each printer configured with a context-analyzer, each data stream that is printed on a particular printer can be analyzed to accumulate information concerning whether the corresponding document is or is not a sensitive document.

With such information having been accumulated (i.e. information concerning the context of documents printed on the printers), the organization is now in a position to accurately analyze the results and make conclusions as to the nature or types of documents that are being printed on individual printers, or on the organization's printers as a whole. In the example above where the context-analyzers are used to ascertain whether sensitive documents are being printed on unsecure printers, if such is found to be the case, the organization might put in place some remedial measures to ensure that this does not occur in the future.

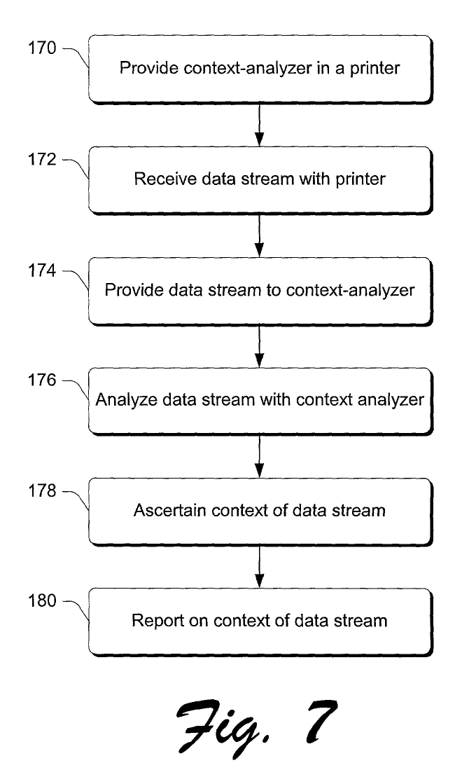

FIG. 6 shows an exemplary context-analyzer 154a in accordance with one embodiment. In this example, the context-analyzer includes a structure detector component 166 and a keyword detector component 168. These components assist the context-analyzer in ascertaining the context of documents associated with data streams that it processes.

The structure detector component 166 can be programmed to analyze a data stream so that it can ascertain the structure of the document that is to be printed. For example, forms that are used throughout an organization are typically standardized in their format or structure. There may be predefined fields within the document that, as with some forms, are always going to be present. Thus, if the specific structure of a document is known ahead of time, the structure detector component can be programmed to look for the specific structure in a data stream. Each time such a structure is found, the context-analyzer 154a can conclude that the data stream is associated with a form of interest.

The keyword detector component 168 works along related but different lines. Consider that certain types of documents typically contain keywords or phrases that are generally known to occur within those types of documents. For example, an employee evaluation form might always include the phrase “Employee Evaluation Form 10A”. Hence, by knowing the types of keywords or phrases that typically occur within certain types of documents, keyword detector component 168 can be programmed to specifically look for those types of keywords or phrases. From this, the context-analyzer can ascertain the type of document that is represented by the data stream.

Thus, in this example, various types documents are able to be described by their profiles. The context-analyzer is able to be programmed to look for specific document profiles in the data streams that represent the documents. By identifying documents that meet certain definable profile characteristics, the context-analyzer can make intelligent decisions as to the nature or type of documents that are being printed.

Exemplary Method

FIG. 7 is a flow diagram that describes steps in a method in accordance with one embodiment. The steps can be implemented in any suitable hardware, software, firmware, or combination thereof. In the illustrated example, most if not all of the steps can be implemented in software.

Step 170 provides a context-analyzer in a printer. The context-analyzer can be provided in the printer in any suitable way. For example, a printer can be originally configured with a context-analyzer when it is built. Alternately, the printer can provided with a context-analyzer at some later date. Any method or mode of delivery can be used to provide the context-analyzer to the printer. For example, the context-analyzer can be loaded onto the printer via a computer-readable medium such as a CD or hard disk. In one particular embodiment, the context-analyzer is delivered to the printer over a network, such as the Internet, in the form of an application or applet that can run on the printer. In addition, in various embodiments the context-analyzer can be self-replicating and self-directing. Specifically, if a context-analyzer is resident on one printer within a network, it can be programmed to seek out other network printer resources, copy itself, and then provide the copy to the other network resources. Accordingly, the context-analyzer can be provided to one or more printers in any number of suitable ways.

Step 172 receives a data stream into the printer on which a context-analyzer resides. The data stream represents a document that is to be printed by the printer. The data stream can be in any suitable form, format or state. Step 174 provides the data stream to the context-analyzer and step 176 analyzes the data stream with the context analyzer. Specific examples of how this can be done are given above and described in connection with FIG. 6. It is to be appreciated and understood that any suitable method can be used for analyzing a data stream for its context. The examples given above, i.e. structure and keyword analysis, constitute but two exemplary ways of analyzing a data stream for its context. Other ways can, of course, be utilized.

Step 178 ascertains one or more contexts associated with the data stream. This step is implemented by evaluating the information that is produced by step 176 and making a decision based upon that information. It should be appreciated and understood that this step—that of evaluating the information produced from an analysis of the data stream—need not be performed by the context-analyzer itself. Rather, the context-analyzer can accumulate information through its analysis of the data stream and then provide the accumulated information to another entity, as noted above, so that the context of the data stream can be ascertained.

Step 180 reports on the context of the data stream. Exemplary ways of implementing this step include, without limitation, the following ways. First, if the context-analyzer is programmed to perform steps 176 and 178, then this step can be implemented by the context-analyzer itself. This can involve reporting the context information to another computing entity (such as a corporate server) via a corporate network. Second, if the context-analyzer is not programmed to perform step 178 (that of ascertaining the context of the data), then this step can be implemented by the entity that did in fact perform this step.

Data Monitoring

In many instances, organizations or, more accurately, information managers or those associated with security functions within an organization are interested in monitoring and overseeing security issues within the organization. One of the security issues, as alluded to in the “Background” section pertains to what is printed on an organization's printers. For example, certain sensitive material may be so sensitive that it is only to be printed on a specific designated secure printer and by a few specially designated people. This material might, for example, concern an organization's corporate strategy or future, yet-to-be-released products. In these instances it becomes especially critical for the organization to police the content of its printers.

Within this context, the context-analyzers of an organization can be configured to monitor for secure information or, for that matter, any information of a specific nature. Upon detecting data streams that correspond to the monitored information, the context-analyzer can generate a notification or send the data stream to an appropriate authority within the organization for further analysis.

Consider again FIG. 5 and the enterprise network 156. Assume in this example that the organization is interested in looking for certain profile material that is being printed on its printers. The profile of such material might be that which is associated with sensitive material, personal material that is being printed on organization resources, or any other material for which an organization may be inclined to monitor. Each of context-analyzers 154 can be configured to look specifically for data streams associated with documents that meet one or more profiles defined by the organization. Accordingly, the context-analyzers are looking at the specific content of the data streams to ascertain whether their associated documents fall within a profile of interest. If a particular data stream is determined to be associated with a profile of interest, a notification or the data stream itself can be sent to another computer for further analysis.

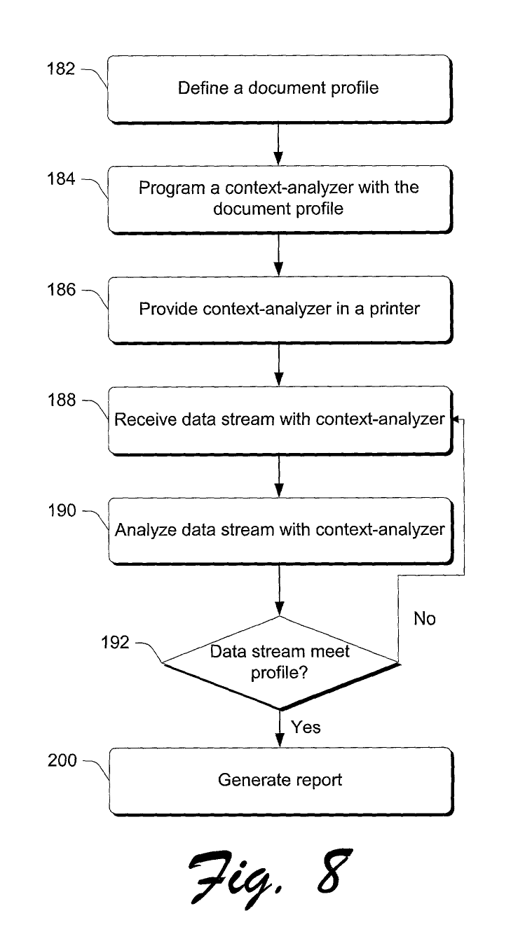

FIG. 8 is a flow diagram that describes steps in a method in accordance with one embodiment. The steps can be implemented in any suitable hardware, software, firmware, or combination thereof In the illustrated example, most if not all of the steps can be implemented in software.

Step 182 defines a document profile. Any suitable document profile can be defined. In addition, any suitable way of defining a particular document profile can be used. In this example, the document profile pertains to a specific document or type of document in which the organization is interested. The profile can be defined in terms of keyworks, clusters of keywords, frequency of occurrence of keywords or phrases, Boolean combinations of keywords or phrases and the like. There are simply numerous known ways to define document profiles that will be appreciated and understood by those of skill in the art. Some exemplary ways are disclosed in the following U.S. Patents, the disclosures of which are incorporated by reference herein: U.S. Pat. Nos. 6,119,114, 6,109,023, 5,995,638, 5,778,363, 5,774,888, and 5,724,567.

Step 184 programs a context-analyzer with the document profile and step 186 provides the context-analyzer in a printer. These steps need not be performed in this order. That is, a context-analyzer can be configured after it is provided in the printer. Step 186 is similar to step 170 in FIG. 7. That is, the context-analyzer can be provided in the printer in any suitable way. Step 188 receives a data stream with the context-analyzer. The data stream that is received by the context-analyzer can constitute any data stream within the printer. Specifically, the data stream can comprise the stream as actually received by the printer, or it can comprise some modified form of the data stream within the printer. Step 190 analyzes the data stream with the context analyzer. This step is implemented by comparing the data stream with the defined document profile. Step 192 determines whether the data stream meets the profile within some degree of certainty. If the data stream appears to meet the profile, then step 200 generates a report pertaining to the data stream. This report can be a simple notification, or it can comprise the data stream itself. The generated report can then be sent onto whatever authority/entity is interested in the report. If, on the other hand, step 192 determines that the data stream does not meet the profile, then the method branches back to step 188 to receive more data streams.

Printer Monitoring

In many instances, having the ability to monitor one or more printers can be of great benefit to an organization. For example, in the area of security, having the ability to oversee printer usage can go a long way in assisting the organization in protecting their resources. Additionally, in the area of printer maintenance, having the ability to interact with and monitor one or more printers can assist an organization in maintaining their printer resources. For example, being able to ascertain whether any of an organization's printers have bad memory, or an I/O blockage can facilitiate a timely repair and reduce downtime.

Security Monitoring

FIG. 9 shows a printer 202, a printer monitor 204, and a printer authority 206 in accordance with one embodiment. Printer 202 can comprise any suitable printer, examples of which are given above. In one particular implementation, printer 202 comprises one of multiple organizational printers that can be used by an organization. Organizational printers are typically networked together for members of the organization to use.

Printer monitor 204 is preferably implemented in software and is communicatively linked with the printer 202. Printer monitor 204 is programmed or programmable to monitor various variables or parameters associated with printer 202. Printer monitor 204 can also be desirably programmed to generate and send notifications to a printer authority 206. In this example, the printer authority can comprise an organization information system manager.

In one embodiment, printer monitor 204 is configured as a printer security monitor. Accordingly, the variables or parameters that it monitors are associated, in some regard, with the security of the printer and/or documents that are or are to be printed on the printer. If the printer monitor, through its monitoring function, ascertains that there has likely been a security breach, the printer monitor can take action such as notifying an appropriate printer authority.

Specifically, in an organization, sensitive material is typically compromised using printers in a couple of different ways. First, when a data stream is sent to a printer for printing, a rogue applet running on the printer can simply make a copy of the data stream and send it out across the I/O port to some other destination. Second, rather than send the data stream immediately out across the I/O port, the rogue applet can collect information of interest in the printer's memory and then, in bursts, send the information across the I/O at another time. Still further, a rogue applet might collect information of interest and then allow it to be printed on the same printer at a later time. In this case, an unauthorized employee might come into the office after hours and print the collected information when no one else is around. Needless to say, there are a number of ways that an unscrupulous person might use to gain access to sensitive material.

In the above examples, there are some common characteristics of the ways that the unscrupulous person might use to access sensitive material. First, many of the ways involve some type of I/O activity. Specifically, if a rogue applet is sending data out of the printer, this involves an I/O activity with the outside world. Typically, in printers, many of the applications that run on the printers have no need to communicate with the outside world. Thus, the presence or frequency of I/O activity where data is being transmitted out of the printer can be indicative of a situation that needs monitoring. Second, some of the ways of accessing sensitive material involve the use of the printer's memory, e.g. by storing data for printing at a later time. Thus, there are some memory usage scenarios that can be suggestive of a situation that needs monitoring. For example, if a certain application also uses printer memory everytime it prints, then this application may be the source of a leak.

Accordingly, in view of the above, some of the variables or parameters that can be monitored by printer monitor 204 include, without limitation, the following:

I/O activities (frequency, timing, and the like)

Memory usage (frequency, timing, and the like)

Ratio of data out vs. data in

Volume of data out

Timing of the data out (i.e. off-business hours)

The I/O activities and memory usage variables have been discussed above. With respect to the timing of such variables, a problem might be present if every time a print job processes there is an I/O activity or an unauthorized or unnecessary memory usage. The ratio of data out versus data in looks at the percentage of data that is sent out of the printer. Higher ratio values may be more indicative of a problem. For example, if the data out/data in ratio is 0.75, then 75% of the material that is printed on the printer is also being transmitted out of the printer-this could be a problem. Additionally, the volume of material or data that is transmitted out of the printer and the timing at which transmissions occur could be indicative of a problem. For example, if some printers by nature print only sensitive information, then even a small amount of data transmitted out of the printer can be indicative of a problem. Similarly, if a large volume of material is transmitted after everyone has gone home for the day, a problem may exist.

In the FIG. 9 example, the printer monitor 204 is shown as external to the printer 204. In this scenario, the printer monitor 204 can comprise part of a printer server or other organization computing device or server that is set up and monitors the various organization printers.

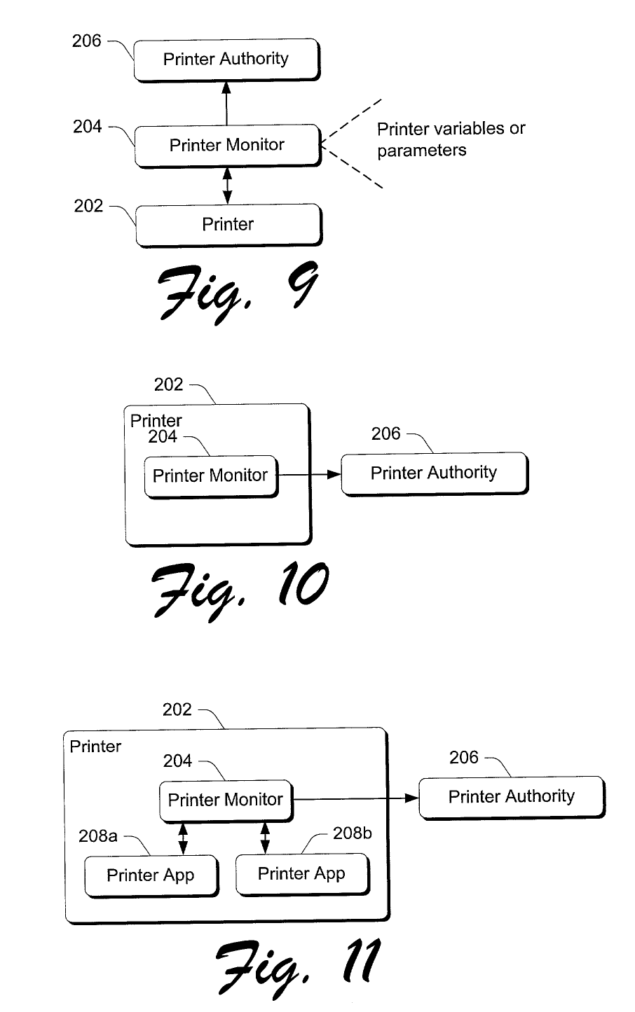

FIG. 10 shows an example where printer monitor 204 is internal to the printer 202. In this example, the printer monitor 204 can comprise a piece of software that is deliverable to and/or resident on the printer. For example, if the printer has a JVM runtime environment, printer monitor 204 can comprise an applet running within the JVM that monitors the printer as described above. FIG. 11, for example, shows printer monitor 204 monitoring different printer applications 208a, 208b. Exemplary applications that the printer monitor can monitor can include, without limitation, authentication applications (i.e. retina identification applications and smart card access applications) to identify who is using a particular printer, disk file management applications to ascertain the movement of and handling of files, language converter applications, consumables consumption applications and various other applications that can be associated with a printer. By monitoring various applications, characteristics associated with those applications can be identified that can be indicative of a situation that needs to be further explored. For example, if a particular person authenticates himself to multiple different printers over a short period of time, and that person transmits a small data out from each printer, then the person may be trying to mask the fact that they are stealing a larger volume of material. Without knowing that the same person was transmitting the data, it might be likely that whatever filter was in place on each filter would miss the fact that data was being stolen due to the fact that only a small amount of data was transmitted from each printer.

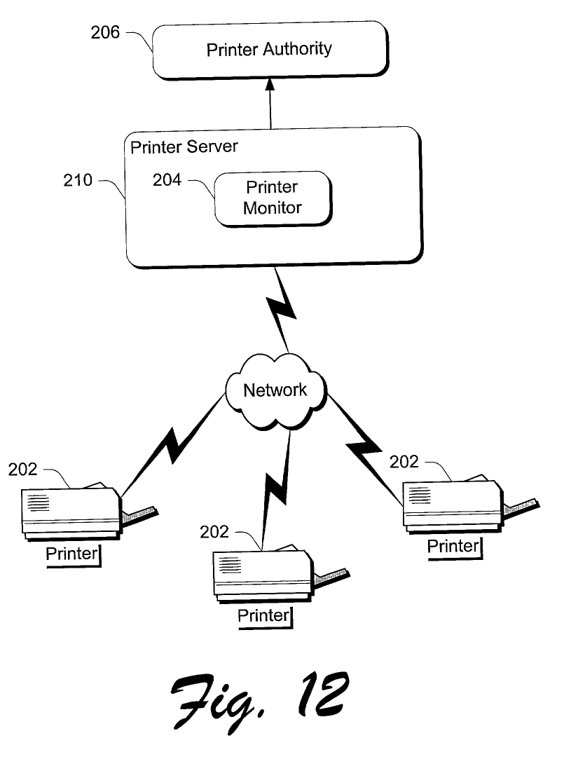

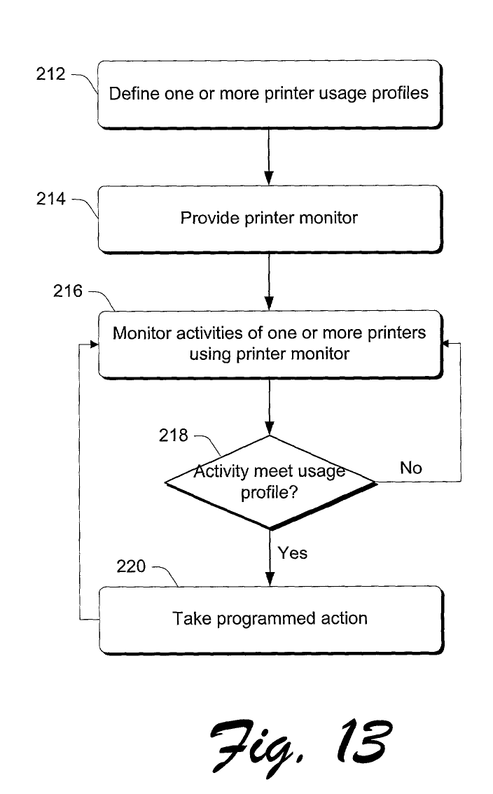

FIG. 12 shows another scenario which is an expansion of the FIG. 9 scenario. Here, an organization network comprises multiple printers 202. A printer monitor 204 is communicatively linked with the printers via a network. In this manner, one printer monitor can monitor multiple different printers. In this particular scenario, the printer monitor 204 is well-positioned to monitor I/O activities of all of the printers since I/O takes place through the network that links the printer monitor with the printers. Additionally, if printer monitor 204 comprises part of a printer server, such as server 210, it is particularly well-suited and positioned to monitor the activities of the printers.

Exemplary Monitoring Method

FIG. 13 is a flow diagram that describes steps in a method in accordance with one described embodiment. The method can be implemented in any suitable hardware, software, firmware, or combination thereof. In the illustrated example, the method is implemented in software.

Step 212 defines one or more printer usage profiles. This step can be implemented by a system administrator such as the MIS (Manager of Information Systems). The printer usage profile can be defined in terms of any suitable variables, parameters, and the like that will meet the needs of the MIS and the organization. Exemplary variables and parameters are given above. In addition, the variables and parameters can be used to define various thresholds of interest. Recall that these variables and parameters were derived from an understanding and appreciation that inappropriate printer activities typically have usage characteristics associated with them. By recognizing what these usage characteristics are, usage profiles can be defined that are directed to identifying, with some degree of certainty, when use of a printer meets one of the characteristics. Consider additionally that the usage profile need not necessarily be one that is associated with inappropriate printer behavior. Rather, a system administrator might define a usage profile that is directed to identifying operational problems with a printer (e.g. bad memory or and I/O blockage). It should be appreciated and understood that the usage profiles that are defined can be, in some embodiments, independent of print job management and printer consumables management (e.g. toner low, paper out etc.).

Step 214 provides a printer monitor that is programmed to monitor one or more printers. The printer monitor is preferably implemented in software and can comprise an internal component of a printer, or it can be external to the printer. If external to the printer, the printer monitor can comprise part of a printer server computer or any other suitable computer.

Step 216 monitors activities of one or more printers using the printer monitor. This step can be implemented by the printer monitor examining various operational aspects of a printer (e.g. I/O usage, memory usage, and the like). Step 218 then determines whether one or more printer activities meets one or more of the usage profiles defined in step 212. If one or more activities meets one or more usage profiles, step 220 takes a programmed action. This step can include generating a notification and sending it to the MIS. Alternately, another other suitable and appropriate programmed actions can take place. If, on the other hand, step 218 determines that an activity does not meet one or more usage profiles, the method branches back to step 216 and continues monitoring the activities.

Conclusion

The above-described methods and systems provide a means by which an organization can monitor their printer resources. The techniques described herein are advantageous from the standpoint of being transparent from the point of view of the user. This can add a degree of stealthyness that in some scenarios can increase the likelihood of the organization uncovering situations that present security risks. The techniques and systems are also advantageous from the standpoint of providing tools for an organization to use to more efficiently manage and oversee its printer resources.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A printing apparatus comprising:
a printer configured to print upon print media; and
a printer monitor associated with the printer and configured to monitor one or more variables or parameters associated with the security of the printer.

2. The printing apparatus of claim 1, wherein the printer monitor is configured to generate one or more notifications to a printer authority in an event of a security breach associated with the printer.

3. The printing apparatus of claim 1, wherein the one or more variables or parameters are associated with the security of documents that are printed on the printer.

4. The printing apparatus of claim 1, wherein the one or more variables or parameters are associated with I/O activities.

5. The printing apparatus of claim 1, wherein the one or more variables or parameters are associated with memory usage activities.

6. The printing apparatus of claim 1, wherein the one or more variables or parameters are associated with data ratios pertaining to an amount of data transmitted by the printer versus an amount of data received by the printer.

7. The printing apparatus of claim 1, wherein the one or more variables or parameters are associated with the volume of data transmitted by the printer.

8. The printing apparatus of claim 1, wherein the printer monitor is external to the printer.

9. The printing apparatus of claim 1, wherein the printer monitor is internal to the printer.

10. The printing apparatus of claim 9, wherein the printer monitor comprises an applet running in the printer's runtime environment.

11. The printing apparatus of claim 9, wherein the printer monitor is configured to monitor multiple different applications on the printer.

12. A printing apparatus comprising:
a printer; and
a printer monitor associated with printer and configured to monitor one or more usage profiles associated with the printer, the one or more usage profiles being independent of profiles associated with print job management or printer consumables management.

13. The printing apparatus of claim 12, wherein the one or more usage profiles are defined in terms of one or more variables or parameters associated with I/O activities of the printer.

14. The printing apparatus of claim 12, wherein the one or more usage profiles are defined in terms of one or more variables or parameters associated with memory usage activities.

15. The printing apparatus of claim 12, wherein the one or more usage profiles are associated with the security of the printer.

16. The printing apparatus of claim 12, wherein the one or more usage profiles are associated with documents that are printed on the printer.

17. The printing apparatus of claim 12, wherein the printer monitor is disposed internally of the printer.

18. The printing apparatus of claim 12, wherein the printer monitor is disposed externally of the printer.

19. A printer management method comprising:
monitoring one or more variables or parameters associated with the security of a printer; and
generating a notification if it appears likely that there has been a security breach.

20. The printer management method of claim 19, wherein said monitoring comprises monitoring one or more variables or parameters associated with security of documents that are to be printed on the printer.

21. The printer management method of claim 19, wherein said monitoring comprises monitoring one or more variables or parameters associated with I/O activities of the printer.

22. The printer management method of claim 19, wherein said monitoring comprises monitoring one or more variables or parameters associated with memory usage activities of the printer.

23. The printer management method of claim 19, wherein said monitoring comprises monitoring one or more variables or parameters associated with data ratios pertaining to an amount of data transmitted by the printer versus an amount of data received by the printer.

24. The printer management method of claim 19, wherein said monitoring comprises monitoring one or more variables or parameters associated with the volume of data transmitted by the printer.

25. The printer management method of claim 19, wherein said monitoring takes place from internally of the printer.

26. The printer management method of claim 19, wherein said monitoring takes place from externally of the printer.

27. A printer management method comprising:
providing multiple printers in an organization;
linking the printers together via an organization network;
monitoring activities of the multiple printers;
determining whether one or more printer activities meets one or more usage profiles associated with each of the printers, the usage profiles being associated with the security of each associated printer; and
taking a programmed action in the event that one or more printer activities meets one or more usage profiles for an associated printer.

28. A printing system comprising:
multiple printers; and
one or more printer monitors associated with one or more of the multiple printers, the one or more printer monitors being configured to monitor one or more variables or parameters associated with the security of the one or more printers.

29. The printing system of claim 28, wherein at least one printer monitor is disposed internally of an associated printer.

30. The printing system of claim 28, wherein at least one printer monitor is disposed externally of an associated printer.

31. The printing system of claim 28, wherein the one or more printer monitors are configured to generate notifications to a printer authority in an event of a security breach.

32. The printing system of claim 28, wherein the one or more printer monitors are configured to monitor one or more variables or parameters associated with I/O activities of the one or more printers.

33. The printing system of claim 28, wherein the one or more printer monitors are configured to monitor one or more variables or parameters associated with memory usage activities of the one or more printers.

34. The printing system of claim 28, wherein the one or more printer monitors are configured to monitor one or more variables or parameters associated with data ratios pertaining to an amount of data transmitted by a printer versus an amount of data received by the printer.

35. The printing system of claim 28, further comprising a network linking the printers together.
